(19) United States
(12) Patent Application Publication
(10) Pub. No.: US 2016/0204562 A1
(43) Pub. Date: Jul. 14, 2016

(54) METHOD FOR MANUFACTURING METAL SHELL AND ELECTRICAL CONNECTOR THEREOF

(71) Applicant: LOTES CO., LTD, Keelung (TW)

(72) Inventors: Jian Fei Chen, Keelung (TW); Shang Ju Tsai, Keelung (TW)

(21) Appl. No.: 14/990,108

(22) Filed: Jan. 7, 2016

(30) Foreign Application Priority Data
Jan. 8, 2015 (CN) 201510007300.7

(51) Int. Cl. H01R 43/16

(52) U.S. Cl. CPC H01R 43/16

(57) ABSTRACT

A method for manufacturing a metal shell and an electrical connector thereof. The method includes the steps of: S1: providing a metal tube, and cutting the metal tube to form a shell of a predetermined length; S2: flaring one end of the shell, so that the shell is formed with a first tube body and a second tube body extending backward from the first tube body, and an aperture of the second tube body is greater than an aperture of the first tube body; and S3: disposing a buckling structure used for cooperating with an insulating body of the electrical connector on a side surface of the shell.

### CROSS-REFERENCE TO RELATED APPLICATION

This non-provisional application claims priority under 35 U.S.C. §119(a) on Patent Application No. 201510007300.7 filed in P.R. China on Jan. 8, 2015, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates to a method for manufacturing a metal shell and an electrical connector thereof, and in particular, to a method for manufacturing an electrical connector used for transmitting a high-frequency signal and a metal shell thereof.

### BACKGROUND OF THE INVENTION

An electrical connector disclosed in Chinese Patent No. CN201120066386.8 includes an insulating body 1 and a metal shell 3 wrapping the insulating body 1. The metal shell 3 includes a plugging end 31 formed in a drawing process manner and a back cover 32 formed in a punching and bending manner. During assembly, the plugging end 31 is sleeved over a tongue portion 12 from the front of the insulating body 1, and then the back cover 32 is sleeved over a retaining portion 11 of the insulating body 1 from the front of the insulating body 1.

The metal shell 3 is formed by the plugging end 31 and the back cover 32, and is sleeved over the insulating body 1. Therefore, comparing to a metal shell 3 formed in a one-piece manner, the metal shell 3 formed in such a two-piece assembly manner has a weak structure strength. When the electrical connector is plugged or unplugged, because of an excessively large external force, the metal shell 3 is easily broken and disengaged from the insulating body 1.

Therefore, a heretofore unaddressed need exists in the art to address the aforementioned deficiencies and inadequacies.

### SUMMARY OF THE INVENTION

In one aspect, the present invention relates to a novel method for manufacturing a metal shell so as to strengthen the structure strength of the metal shell, where when an electrical connector is subject to an excessively large external force, the metal shell wrapping the electrical connector is not easily broken and disengaged from the electrical connector.

In one aspect, the present invention relates to a method for manufacturing a metal shell for an electrical connector. The method includes the steps of:

S1: providing a metal tube, and cutting the metal tube to form a shell of a predetermined length;

S2: flaring one end of the shell, so that the shell is formed with a first tube body and a second tube body extending backward from the first tube body, and an aperture of the second tube body is greater than an aperture of the first tube body; and

S3: disposing a buckling structure for cooperating with an insulating body of the electrical connector on a side surface of the shell.

In one embodiment, the method further includes, after step S3, leveling the second tube body.

In one embodiment, the method further includes:

chamfering a front edge of the first tube body to form a chamfered edge, wherein the chamfered edge defines a mating frame opening for cooperating with a mating connector, and an aperture of the mating frame opening is less than an inner diameter of the first tube body.

In one embodiment, the mating frame opening is elliptic, the electrical connector further comprises a first terminal group and a second terminal group that are accommodated in the insulating body and disposed in an upper row and a lower row, and an upper shielding sheet, a middle shielding sheet, and a lower shielding sheet that are retained to the insulating body, the upper shielding sheet is located above the first terminal group, the middle shielding sheet is located between the first terminal group and the second terminal group, the lower shielding sheet is located below the second terminal group, and each of the upper shielding sheet and the lower shielding sheet is provided with a grounding portion in contact with the shell.

In one embodiment, the metal tube is formed in a non-extension manner.

In one embodiment, the metal tube is formed by winding a plate material, and soldering a seam.

In one embodiment, the buckling structure is disposed on the second tube body.

In one embodiment, the buckling structure is a positioning hole, and the insulating body is provided with a protruding block buckled in the positioning hole.

In one embodiment, the protruding block is provided with a groove, and a retaining portion buckled in the groove extends from a side of the positioning hole into the positioning hole.

In one embodiment, the method further includes, after step S2:

cutting a back end of the second tube body, such that the back end of the second tube body is formed with a soldering leg used for being soldered onto a circuit board to enable the shell to be grounded.

In one embodiment, the electrical connector further includes an upper cover and a lower cover, the upper cover and the lower cover are snap-fit with each other and located above and below the second tube body, an upper resisting portion resisting a front edge of the second tube body is bent downward from a front edge of the upper cover, and a lower resisting portion resisting the front edge of the second tube body is bent upward from a front edge of the lower cover.

In one embodiment, the upper resisting portion and the lower resisting portion define an elliptic opening.

In one embodiment, the second tube body comprises a connection portion connected to the first tube body, and the connection portion is arc shaped.

In one embodiment, a front edge of the first tube body is bent into the first tube body to form a stopping portion to stop the insulating body.

In one aspect, the present invention relates to a method for manufacturing a metal shell for an electrical connector. The method includes the steps of:

S1: providing a metal tube, and cutting the metal tube to form a shell of a predetermined length;

S2: flaring one end of the shell, so that the shell is formed with a first tube body and a second tube body extending backward from the first tube body, and an aperture of the second tube body is greater than an aperture of the first tube body; and

S3: chamfering a front edge of the first tube body to form a chamfered edge, wherein the chamfered edge defines a mating frame opening for cooperating with a mating connector, and an aperture of the mating frame opening is less than an inner diameter of the first tube body.

In one embodiment, the mating frame opening is elliptic, the electrical connector further comprises an insulating body accommodated in the shell, a first terminal group and a second terminal group that are accommodated in the insulating body and disposed in an upper row and a lower row, and an upper shielding sheet, a middle shielding sheet, and a lower shielding sheet that are retained to the insulating body, the upper shielding sheet is located above the first terminal group, the middle shielding sheet is located between the first terminal group and the second terminal group, the lower shielding sheet is located below the second terminal group, and each of the upper shielding sheet and the lower shielding sheet is provided with a grounding portion in contact with the shell.

In one embodiment, a buckling structure for cooperating with an insulating body of the electrical connector is disposed on a side surface of the shell.

In one embodiment, the electrical connector further comprises an upper cover and a lower cover, the upper cover and the lower cover are snap-fit with each other and located above and below the second tube body, an upper resisting portion resisting a front edge of the second tube body is bent downward from a front edge of the upper cover, and a lower resisting portion resisting the front edge of the second tube body is bent upward from a front edge of the lower cover.

In one embodiment, the second tube body comprises a connection portion connected to the first tube body, and the connection portion is arc shaped.

In one embodiment, a front edge of the first tube body is bent into the first tube body to form a stopping portion to stop the insulating body.

Compared with the prior art, in certain embodiments of the present invention, one end of the shell is flared, so that the shell is formed with the first tube body and the second tube body that are integral, where the aperture of the second tube body is greater than the aperture of the first tube body; therefore the structure strength of the shell is enhanced, and finally a buckling structure disposed on a side surface of the shell cooperates with the insulating body of the electrical connector.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a flowchart of manufacturing a metal shell according to a first embodiment of the present invention.

FIG. 2 is a schematic three-dimensional exploded view showing that the metal shell according to the first embodiment of the present invention is applied to an electrical connector.

FIG. 3 is a schematic three-dimensional exploded view of a shell and an insulating body.

FIG. 4 is a schematic three-dimensional exploded view of the shell and the insulating body at another viewing angle.

FIG. 5 is a partial assembly view of FIG. 2.

FIG. 6 is an assembly view of FIG. 2.

FIG. 7 is a sectional view of FIG. 6.

FIG. 8 is a sectional view of FIG. 3 after assembly.

FIG. 9 is a schematic three-dimensional diagram of a metal shell according to a second embodiment.

FIG. 10 is a side view showing that the metal shell of FIG. 9 and a circuit board are soldered together.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

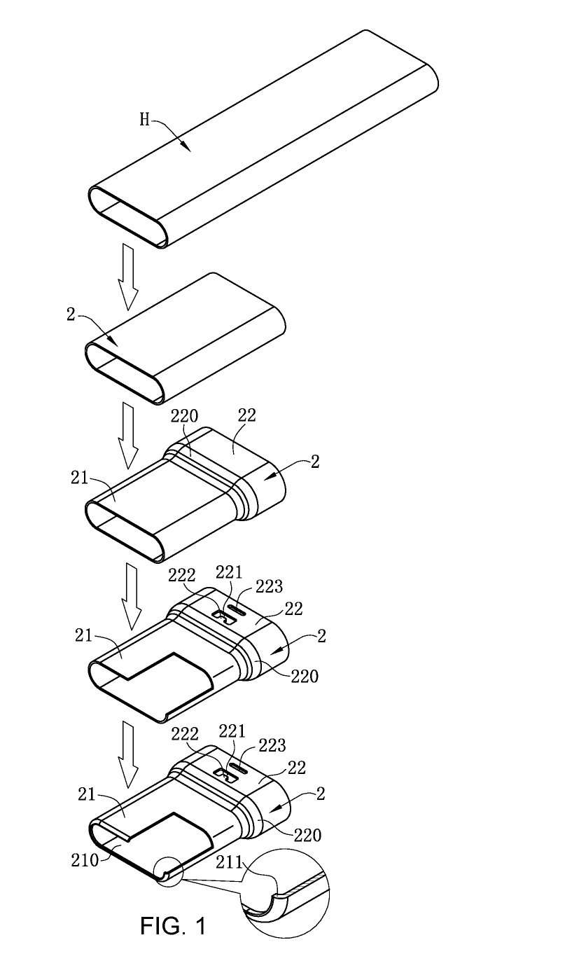

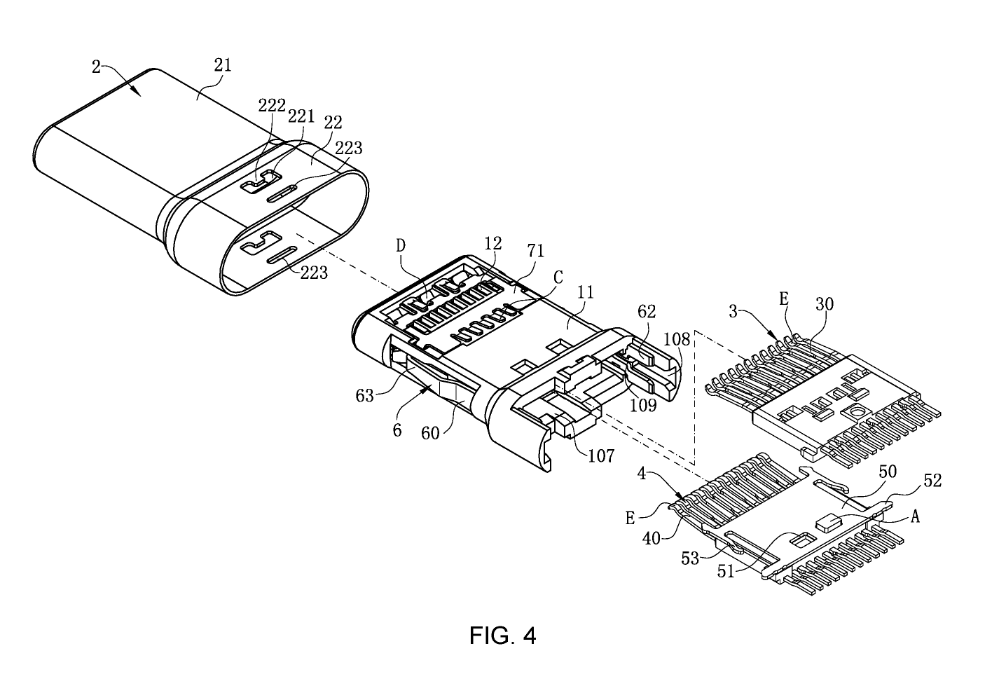

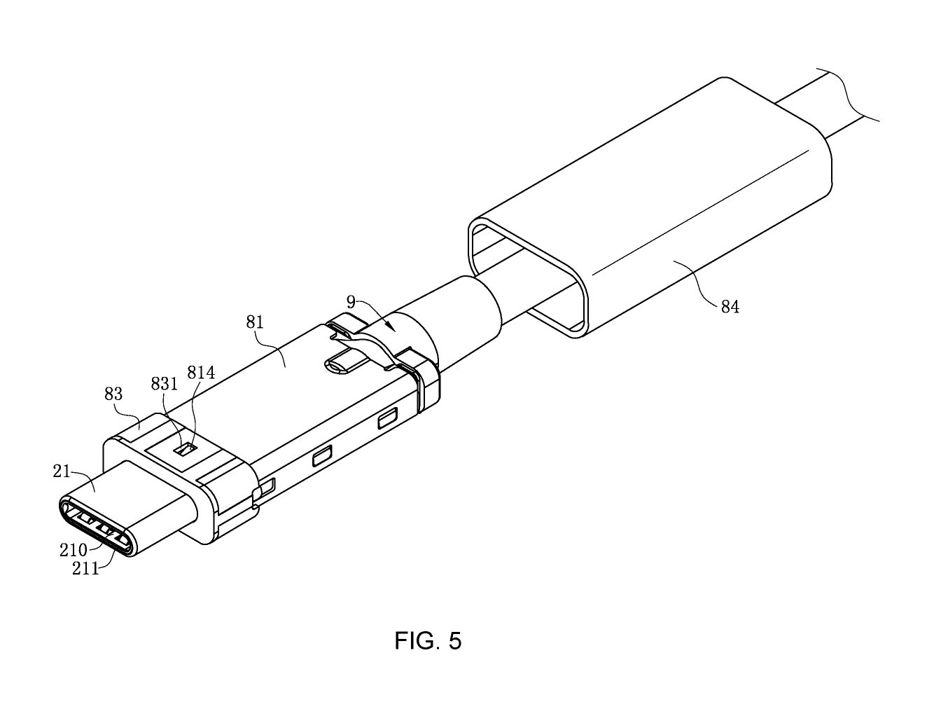

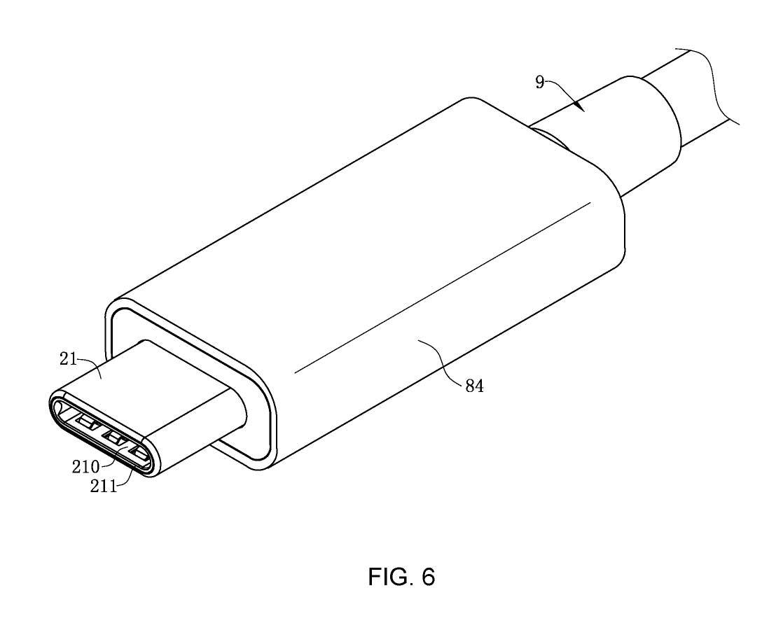

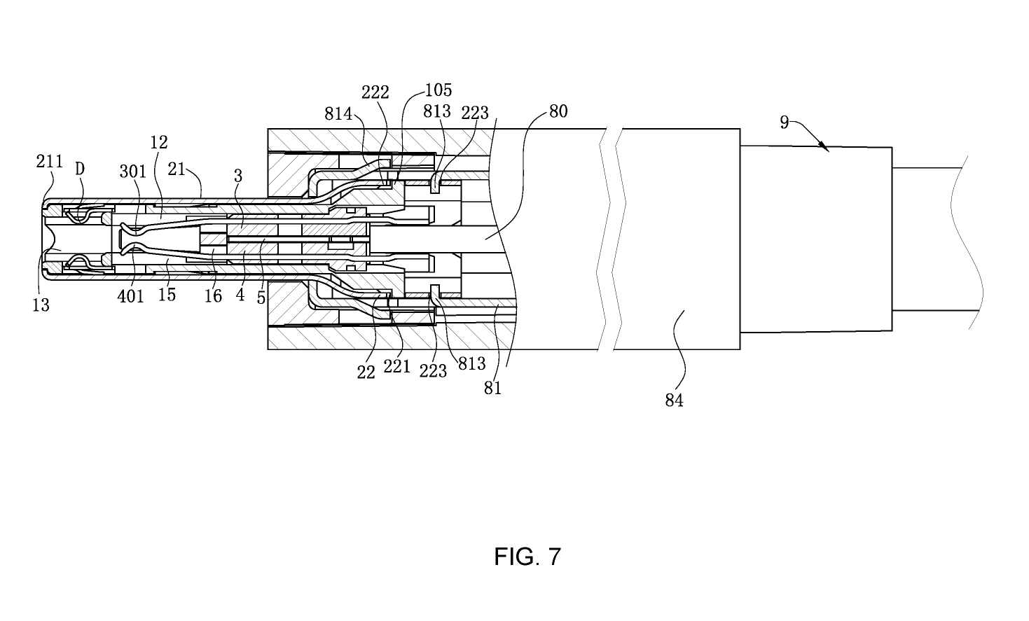

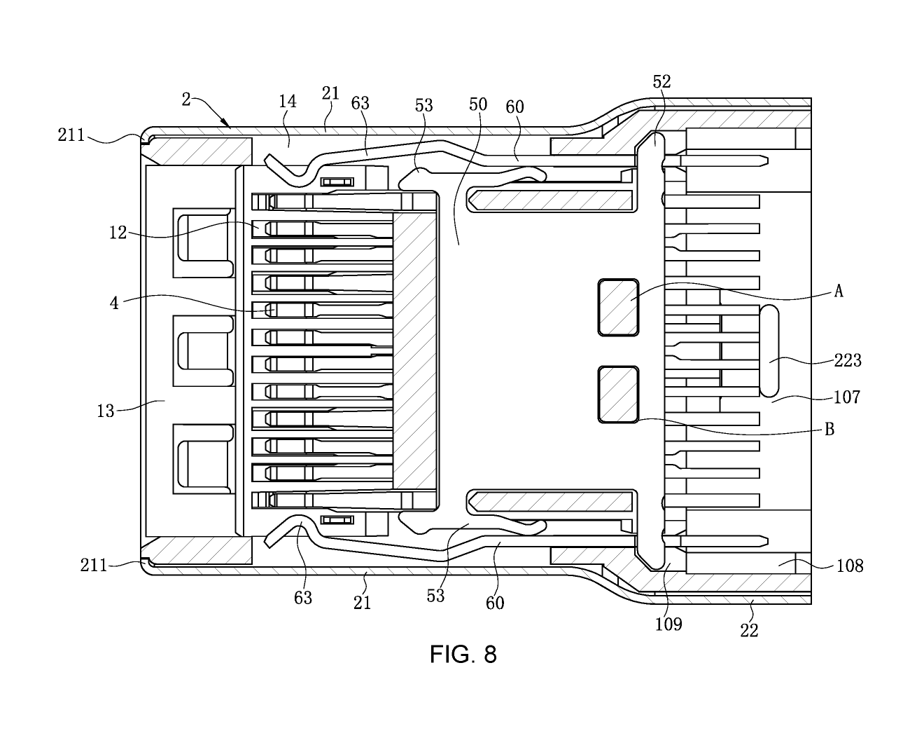

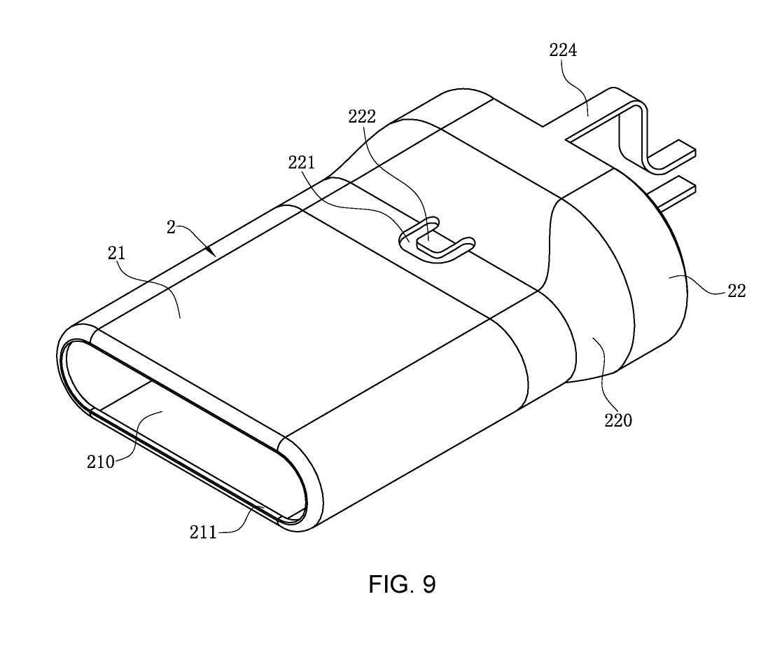

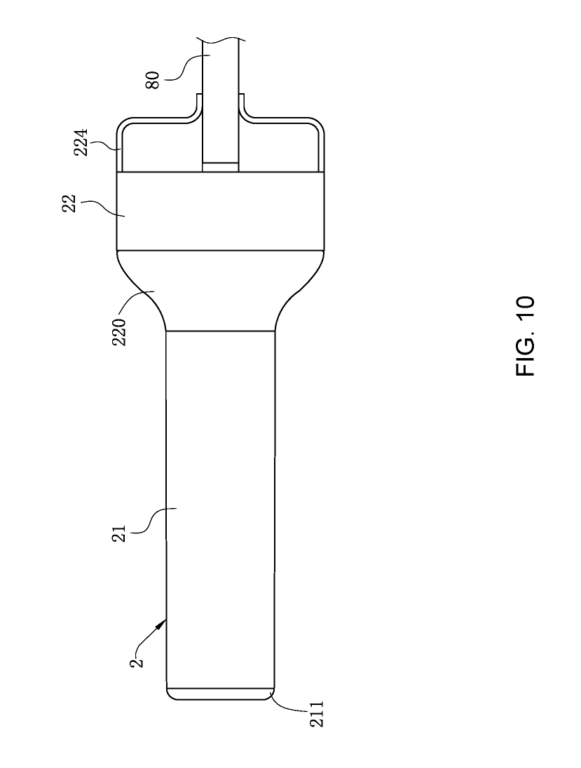

The description will be made as to the embodiments of the present invention in conjunction with the accompanying drawings in FIGS. 1-10. In accordance with the purposes of this invention, as embodied and broadly described herein, this invention, in one aspect, relates to a method for manufacturing a metal shell and an electrical connector thereof.

Referring to FIG. 1, a method for manufacturing a metal shell 2 according to a first embodiment of the present invention is shown, and includes the following steps:

Step S1: Provide a metal tube H formed in a non-extension manner. In this embodiment, the metal tube H is formed by winding a metal plate material, and soldering a seam (in other embodiments, the metal tube H may be formed by means of extrusion), and the metal tube is elliptic. The metal tube H is cut, so as to form the shell 2 of a predetermined length.

Then, step S2 is performed: flaring one end of the shell 2, so that the shell 2 is formed with a first tube body 21 and a second tube body 22 extending backward from the first tube body 21. The aperture of the second tube body 22 is greater than the aperture of the first tube body 21.

Then, step S3 is performed: disposing a positioning hole 221 on each of an upper surface and a lower surface of the second tube body 22. A retaining portion 222 extends from a side of the positioning hole 221 into the positioning hole 221.

Then, step S4 is performed: chamfering a front edge of the first tube body 21, where the chamfered edge defines an elliptic mating frame opening 210. The chamfering is flanging the front edge of the first tube body 21 to the inner side of the first tube body 21.

Then, step S5 is performed: leveling a back end of the second tube body 22.

In a second embodiment, referring to FIGS. 1, 9 and 10, the second embodiment is different from the first embodiment in that after step S2, the following steps are performed: cutting the back end of the second tube body 22, so that each of the upper surface and the lower surface of the second tube body 22 has a soldering leg 224, and then bending the soldering legs 224, so that an angle exists between each of the soldering legs 224 and the second tube body 22. The soldering legs 224 are surface mounted on a circuit board 80 so that the shell 2 is directly grounded (in other embodiments, the soldering legs 224 may extend backward from an upper surface of the first tube body 21 and is then bent downward, so that the soldering legs 224 are perforation soldered onto the circuit board 80).

Referring to FIGS. 1-4, the shell 2 manufactured by using the first embodiment of the present invention is applied to an electrical connector (in other embodiments, the shell 2 may be not applied to the electrical connector). The electrical connector is used for connecting to a mating connector (not shown). The electrical connector conforms to the Type C specification of the USB organization (in other embodiments, the electrical connector may not conform to the Type C specification of the USB organization). The electrical connector includes an insulating body 1, a first terminal group 30 and a second terminal group 40 that are disposed vertically and soldered onto a circuit board 80, and the shell 2 wrapping the insulating body 1, the first terminal group 30 and the second terminal group 40.

Referring to FIGS. 1, 2 and 7, the front edge of the first tube body 21 is chamfered to form a stopping portion 211 used for stopping the insulating body 1 from moving forward. The chamfered edge defines the mating frame opening 210 used for cooperating with the mating connector (not shown). The mating frame opening 210 is elliptic and the aperture of the mating frame opening 210 is less than the inner diameter of the first tube body 21. Viewed from a vertical direction, the vertical aperture of the second tube body 22 is greater than the vertical aperture of the first tube body 21. Moreover, viewed from a horizontal direction, the horizontal aperture of the second tube body 22 is greater than the horizontal aperture of the first tube body 21 (in other embodiments, only the vertical aperture of the second tube body 22 may be greater than the vertical aperture of the first tube body 21 or only the horizontal aperture of the second tube body 22 may be greater than the horizontal aperture of the first tube body 21). The second tube body 22 includes an arc-shaped connection portion, and the connection portion is depressed downward and connected to the first tube body 21. Each of the upper surface and the lower surface of the second tube body 22 is provided with a buckling structure cooperatively fixed to the insulating body 1 (in other embodiments, the buckling structure may be disposed on the first tube body 21 or disposed at a place at which the first tube body 21 and the second tube body 22 are connected). Each of the buckling structure is a positioning hole 221, a retaining portion 222 extends from a side of the positioning hole 221 into the positioning hole 221, and each of the upper surface and the lower surface of the second tube body 22 is further provided with a buckling hole 223 located behind the positioning hole 221.

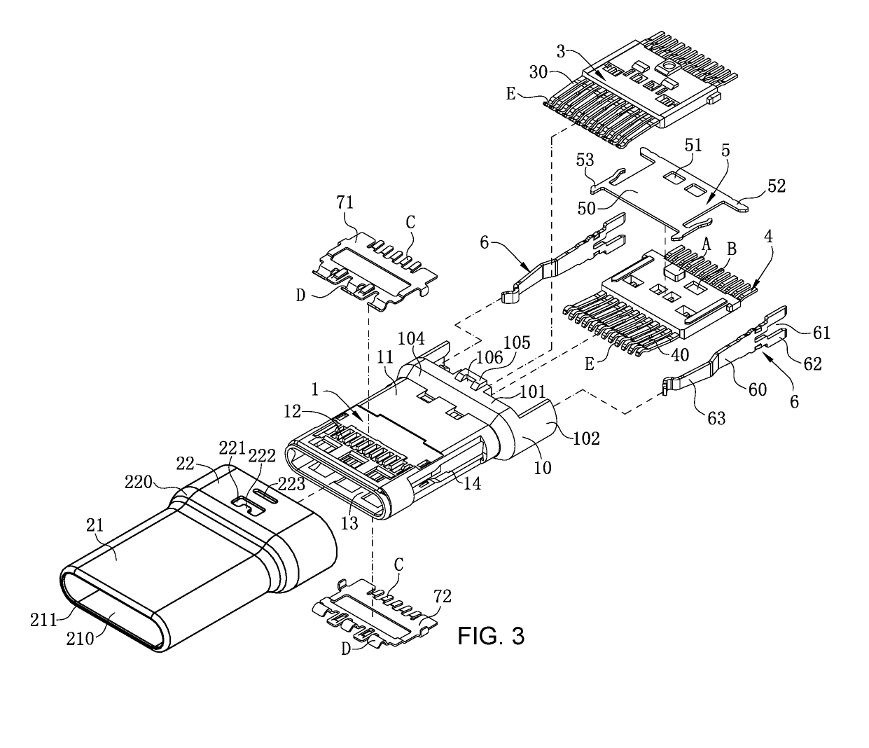

Referring to FIGS. 3, 4 and 7, the insulating body 1 is made of a plastic material, and includes a base 10, a frame 11 extending forward from the base 10, an upper module 3 and a lower module 4. The thickness of the base 10 in the vertical direction is greater than the thickness of the frame 11. The base 10 is accommodated in the second tube body 22. The base 10 includes a top wall 101, a bottom wall (not labeled) opposite to the top wall 101, two side walls 102 connecting the top wall 101 and the bottom wall, and a slant wall 104 slanting forward and connected to the frame 11. A protruding block 105 protrudes from each of the top wall 101 and the bottom wall, and is locked in the positioning hole 221. A groove 106 is depressed forward from each of the protruding blocks 105, and is buckled to the retaining portion 222. The back end of the top wall 101 runs through the back end of the bottom wall to form an accommodating portion 107. The protruding block 105 is located above the accommodating portion 107. Each of the two side walls 102 is provided with a positioning slot 108 and a fixing slot 109 located in front of the positioning slot 108. The positioning slots 108 and the fixing slots 109 are in communication with the accommodating portion 107. The frame 11 is accommodated in the first tube body 21 and stopped by the stopping portion 211 from moving forward. The front end of the frame 11 is provided with multiple terminal slots that are separately an upper row of multiple terminal slots 12 partially running through the top surface of the frame 11 and a lower row of multiple terminal slots 15 partially running through the bottom surface of the frame 11. The first terminal group 30 is located in the upper row of terminal slots 12, and the second terminal group 40 is located in the lower row of terminal slots 15. The structure of the first terminal group 30 is the same as that of the second terminal group 40. Each terminal of the first terminal group 30 and the second terminal group 40 has a conducting portion E located in the terminal slot. A positioning space 16 is provided forward from the back end surface of the frame 11. The accommodating portion 107 is in communication with the positioning space 16, the terminal slot is also in communication with the positioning space 16, and the upper module 3 and the lower module 4 are located in the positioning space 16. The front end of the frame 11 is provided with a mating space 13 used for accommodating the mating connector (not shown). The mating space 13 is in communication with the upper row of terminal slots 12 and the lower row of terminal slots 15. A hollowing portion 14 is depressed from a front end of each of the two opposite side walls 102 of the frame 11. The upper module 3 is located above the lower module 4. The upper module 3 and the first terminal group 30 are insert molded integrally, and the lower module 4 and the second terminal group 40 are insert molded integrally. A clamping block A protrudes from the bottom surface of the upper module 3, a locking slot B is depressed from the bottom surface of the upper module 3. A locking slot B is depressed from the top surface of the lower module 4, a clamping block A protrudes from the top surface of the lower module 4. The clamping block A of the upper module 3 is locked to the locking slot B of the lower module 4, and the clamping block A of the lower module 4 is locked to the locking slot B of the upper module 3, so as to assemble and fix the upper module 3 and the lower module 4.

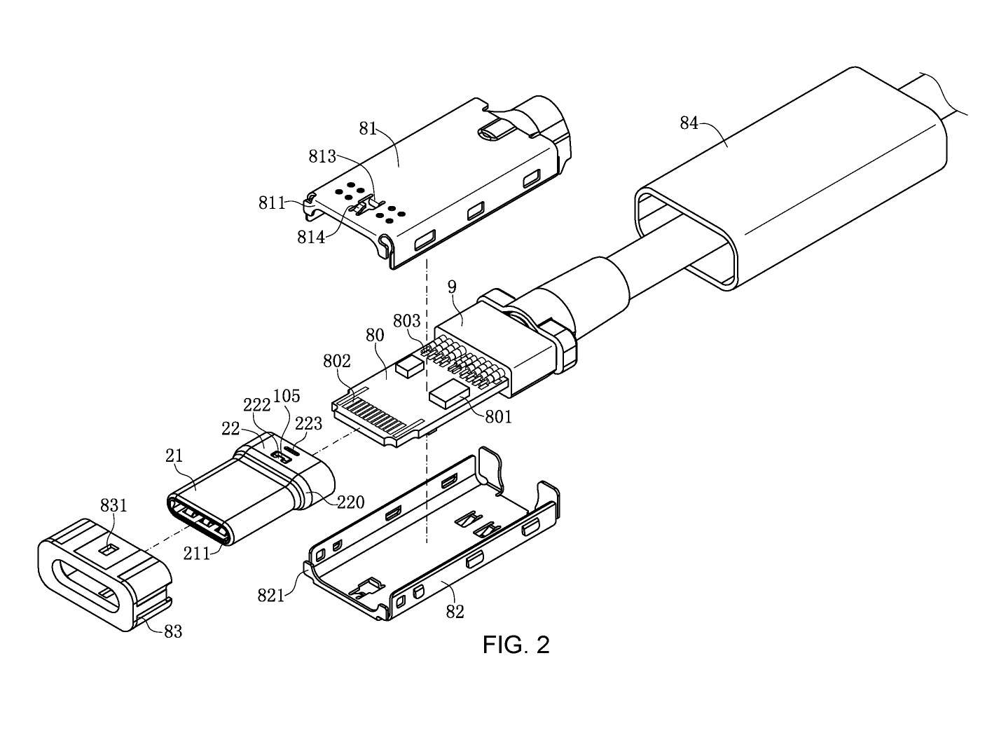

Referring to FIGS. 2, 5 and 6, the circuit board 80 includes an adapting end 802 accommodated in the accommodating portion 107. A left side and a right side of the adapting end 802 are buckled in the positioning slot 108, and the first terminal group 30 and the second terminal group 40 are surface soldered to the adapting end 802. Each of the upper surface and the lower surface of the circuit board 80 is provided with two control chips 801, and the control chips 801 are exposed from the second tube body 22. The circuit board 80 further includes a mating end 803 located behind the adapting end 802 and used for soldering a cable 9.

Referring to FIGS. 2, 5 and 7, the electrical connector further includes an upper cover 81 and a lower cover 82 located above and below the second tube body 22. The upper cover 81 and the lower cover 82 are snap-fit together to wrap the circuit board 80. An upper resisting portion 811 is bent downward from the front edge of the upper cover 81 and resists the front edge of the second tube body 22. The upper cover 81 is provided with a hole (not labeled). A buckling arm 813 extends and is bent into the hole from the back side of the hole and is buckled in the buckling hole 223. An elastic arm 814 is disposed upward from the front side of the hole into the hole and is opposite to the buckling arm 813. A lower resisting portion 821 is bent upward from the front edge of the lower cover 82 and resists the front edge of the second tube body 22. The lower cover 82 is also provided with the buckling arm 813 buckled in the buckling hole 223. The upper resisting portion 811 and the lower resisting portion 821 define an elliptic opening.

Referring to FIGS. 2, 5 and 7, the electrical connector further includes a sleeve 83 located above the second tube body 22 and wrapping the upper cover 81 and the lower cover 82, and a shielding casing 84 wrapping the sleeve 83, the upper cover 81 and the lower cover 82. A locking hole 831 is depressed from the sleeve 83 and locked and fixed to the elastic arm 814.

Referring to FIGS. 3, 4 and 8, the electrical connector further includes two retaining elastic sheets 6 (in other embodiments, there may be one or more retaining elastic sheets 6) retained in the insulating body 1. One end of the retaining elastic sheet 6 is provided with a groove 61. Each of two sides of the groove 61 is provided with a fixing portion 62. The fixing portions 62 are fixed to the inner side of the side wall 102 of the base 10. A plate body portion 60 extends from the fixing portions 62. The plate body portion 60 is located in the frame 11. An elastic portion 63 extends forward from the plate body portion 60, protrudes from the frame 11 and enters the hollowing portion 14. The elastic portion 63 is a free end of the retaining elastic sheet 6. The elastic portion 63 is located at the hollowing portion 14 in a movable manner, and the elastic portion 63 is located at the front end of the insulating body 1, resists the mating electrical connector, and is used for providing the electrical connector with a stable plugging or unplugging force, so as to ensure that the electrical connector and the mating connector are mated firmly, and it is not easy for a looseness problem to occur.

Referring to FIGS. 3, 7 and 8, the electrical connector further includes a middle shielding sheet 5, located between the first terminal group 30 and the second terminal group 40, and shielding an interference signal between the plate surface of the first terminal group 30 and the plate surface of the second terminal group 40. The middle shielding sheet 5 has a main body portion 50 located between the upper module 3 and the lower module 4, a protruding portion 52 extends toward a horizontal direction from each of two sides of the back end of the main body portion 50, each protruding portion 52 passes through the groove 61, projects from the groove 61 and is located in the fixing slot 109. When passing through the groove 61, each protruding portion 52 contacts a side wall surface of the groove 61. The front end of the main body portion 50 is bent and extends toward the protruding portion 52 to form two urging portions 53 (in other embodiments, there may be one or more urging portions 53) urging the plate body portion 60. An extending direction of the urging portion 53 and an extending direction of the protruding portion 52 are perpendicular to each other. The urging portions 53 are elastic, and the urging portions 53 elastically urge the plate body portion 60. The main body portion 50 are provided with two installing holes 51 corresponding to the clamping block A of the upper module 3 and the clamping block A of the lower module 4. When the upper module 3 and the lower module 4 are locked and fixed, the clamping block A passes through the corresponding installing hole 51 to cooperate with the corresponding locking slot B, and the middle shielding sheet 5 is fixed between the upper module 3 and the lower module 4. Therefore, the middle shielding sheet 5 is fixed simply, and easily assembled, and no other fixing structure needs to be added to perform fixing, so that the structure is simple.

Referring to FIGS. 3, 4 and 7, the electrical connector further includes an upper shielding sheet 71 and a lower shielding sheet 72. The upper shielding sheet 71 is fixed to the top surface of the frame 11, the lower shielding sheet 72 is fixed to the bottom surface of the frame 11, and the upper shielding sheet 71 and the lower shielding sheet 72 are both located in the shell 2, and are in contact with the shell 2. The upper shielding sheet 71 is located above the first terminal group 30, and used for shielding an interference signal above the first terminal group 30. The lower shielding sheet 72 is located below the second terminal group 40, and used for shielding an interference signal below the second terminal group 40. Five grounding portions C protrude backward from each of the back end of the upper shielding sheet 71 and the back end of the lower shielding sheet 72 and are in contact with the shell 2 (in other embodiments, there may be one or more grounding portions C). Three mating portions D are bent into the mating space 13 from each of the front end of the upper shielding sheet 71 and the front end of the lower shielding sheet 72 and are in contact with the mating connector.

The manufacturing method according to certain embodiments of the present invention, among other things, has the following beneficial advantages:

1. In certain embodiments of the present invention, a metal tube body H is first cut to form the shell 2 conforming to a specification length of the electrical connector, and then the back end of the shell 2 is flared to form the first tube body 21 and the second tube body 22 of a relatively large tube diameter, so that the first tube body 21 wraps the frame 11, the second tube body 22 wraps the base 10, and the shell 2 is formed in a flaring manner with the first tube body 21 and the second tube body 22 that are integral to wrap the insulating body 1, thereby ensuring that the shell 2 has sufficient structure strength.

2. In certain embodiments of the present invention, the metal tube H may be also formed by winding a metal plate material, and soldering a seam, and then the metal tube H is cut to form the shell 2 of a predetermined length. For a metal shell 3 in the field, if the shell 2 and the soldering leg 224 similar to the present invention are formed in a drawing process manner, a decorative pattern is easily caused on the surface of the metal shell 3 and the thickness is not easily controlled. In contrast, the metal tube H according to certain embodiments of the present invention may be cut into the shell 2 of a comparatively large length, the surface of the shell 2 is kept smooth, and the thickness of the shell 2 is easily controlled.

3. In certain embodiments of the present invention, after the back end of the shell 2 is flared, the back end of the shell 2 is cut, so that the upper surface and the lower surface of the back end of the second tube body 22 are formed with the soldering legs 224, and the shell 2 may be directly soldered onto the circuit board 80 and directly grounded. In this way, the shell 2 may be grounded without contacting the upper shielding sheet 71 and the lower shielding sheet 72, so as to simplify the grounding structure of the shell 2.

4. The two retaining elastic sheets 6 are respectively located at two opposite sides of the first terminal group 30 and the second terminal group 40, and are in contact with the middle shielding sheet 5, so as to eliminate an interference signal between two side surfaces of the first terminal group 30 and the second terminal group 40. The middle shielding sheet 5 is located between the first terminal group 30 and the second terminal group 40, so as to eliminate an interference signal between the plate surface of the first terminal group 30 and the plate surface of the second terminal group 40, and therefore the retaining elastic sheets 6 and the middle shielding sheet 5 are disposed to enhance an anti-interference capability of the electrical connector, so that the electrical connector has a good shielding effect, and improves signal transmission quality.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for manufacturing a metal shell for an electrical connector, comprising the steps of:
S1: providing a metal tube, and cutting the metal tube to form a shell of a predetermined length;
S2: flaring one end of the shell, so that the shell is formed with a first tube body and a second tube body extending backward from the first tube body, and an aperture of the second tube body is greater than an aperture of the first tube body; and
S3: disposing a buckling structure for cooperating with an insulating body of the electrical connector on a side surface of the shell.

2. The method of claim 1, further comprising, after step S3:
leveling the second tube body.

3. The method of claim 1, further comprising:
chamfering a front edge of the first tube body to form a chamfered edge, wherein the chamfered edge defines a mating frame opening for cooperating with a mating connector, and an aperture of the mating frame opening is less than an inner diameter of the first tube body.

4. The method of claim 3, wherein the mating frame opening is elliptic, the electrical connector further comprises a first terminal group and a second terminal group that are accommodated in the insulating body and disposed in an upper row and a lower row, and an upper shielding sheet, a middle shielding sheet, and a lower shielding sheet that are retained to the insulating body, the upper shielding sheet is located above the first terminal group, the middle shielding sheet is located between the first terminal group and the second terminal group, the lower shielding sheet is located below the second terminal group, and each of the upper shielding sheet and the lower shielding sheet is provided with a grounding portion in contact with the shell.

5. The method of claim 1, wherein the metal tube is formed in a non-extension manner.

6. The method of claim 1, wherein the metal tube is formed by winding a plate material, and soldering a seam.

7. The method of claim 1, wherein the buckling structure is disposed on the second tube body.

8. The method of claim 1, wherein the buckling structure is a positioning hole, and the insulating body is provided with a protruding block buckled in the positioning hole.

9. The method of claim 8, wherein the protruding block is provided with a groove, and a retaining portion buckled in the groove extends from a side of the positioning hole into the positioning hole.

10. The method of claim 1, further comprising, after step S2:
cutting a back end of the second tube body, such that the back end of the second tube body is formed with a soldering leg used for being soldered onto a circuit board to enable the shell to be grounded.

11. The method of claim 1, wherein the electrical connector further comprises an upper cover and a lower cover, the upper cover and the lower cover are snap-fit with each other and located above and below the second tube body, an upper resisting portion resisting a front edge of the second tube body is bent downward from a front edge of the upper cover, and a lower resisting portion resisting the front edge of the second tube body is bent upward from a front edge of the lower cover.

12. The method of claim 11, wherein the upper resisting portion and the lower resisting portion define an elliptic opening.

13. The method of claim 1, wherein the second tube body comprises a connection portion connected to the first tube body, and the connection portion is arc shaped.

14. The method of claim 1, wherein a front edge of the first tube body is bent into the first tube body to form a stopping portion to stop the insulating body.

15. A method for manufacturing a metal shell for an electrical connector, comprising the steps of:
S1: providing a metal tube, and cutting the metal tube to form a shell of a predetermined length;
S2: flaring one end of the shell, so that the shell is formed with a first tube body and a second tube body extending backward from the first tube body, and an aperture of the second tube body is greater than an aperture of the first tube body; and
S3: chamfering a front edge of the first tube body to form a chamfered edge, wherein the chamfered edge defines a mating frame opening for cooperating with a mating connector, and an aperture of the mating frame opening is less than an inner diameter of the first tube body.

16. The method of claim 15, wherein the mating frame opening is elliptic, the electrical connector further comprises an insulating body accommodated in the shell, a first terminal group and a second terminal group that are accommodated in the insulating body and disposed in an upper row and a lower row, and an upper shielding sheet, a middle shielding sheet, and a lower shielding sheet that are retained to the insulating body, the upper shielding sheet is located above the first terminal group, the middle shielding sheet is located between the first terminal group and the second terminal group, the lower shielding sheet is located below the second terminal group, and each of the upper shielding sheet and the lower shielding sheet is provided with a grounding portion in contact with the shell.

17. The method of claim 15, wherein a buckling structure for cooperating with an insulating body of the electrical connector is disposed on a side surface of the shell.

18. The method of claim 15, wherein the electrical connector further comprises an upper cover and a lower cover, the upper cover and the lower cover are snap-fit with each other and located above and below the second tube body, an upper resisting portion resisting a front edge of the second tube body is bent downward from a front edge of the upper cover, and a lower resisting portion resisting the front edge of the second tube body is bent upward from a front edge of the lower cover.

19. The method of claim 15, wherein the second tube body comprises a connection portion connected to the first tube body, and the connection portion is arc shaped.

20. The method of claim 15, wherein a front edge of the first tube body is bent into the first tube body to form a stopping portion to stop the insulating body.
